(19) United States
(12) Patent Application Publication
(10) Pub. No.: US 2003/0214908 A1
(43) Pub. Date: Nov. 20, 2003

(54) Methods and apparatus for quality of service control for TCP aggregates at a bottleneck link in the internet

(76) Inventors: Anurag Kumar, Bangalore (IN); Malati Hegde, Bangalore (IN); Joy Kuri, Bangalore (IN); Anand S.V.R., Bangalore (IN); S. Shivshankari, (US)

Correspondence Address: John M. Kelly, The Law Firm of John M. Kelly, 2117 L Street, NW # 347, Washington, DC, 20037, US

(21) Appl. No.: 10/388,770

(22) Filed: Mar. 17, 2003

(30) Foreign Application Priority Data
Mar. 19, 2002 (IN) 248/DEL/2002

(51) Int. Cl. H04L 1/00

(52) U.S. Cl. 370/234; 370/477

(57) ABSTRACT

A network device that is inserted in the path of traffic in a packet network, and the associated procedures and controller algorithms for monitoring the performance of aggregates of short lived Transmission Control Protocol (TCP) Connections flowing over a bottleneck link and dynamically managing their performance. TCP operates by allowing a certain window of data to be outstanding between the source and the receiver of each transfer and if many transfers attempt to share the network, congestion occurs, thus reducing the transmission rate of ongoing transfers. The method and apparatus aim at the performance of an aggregate of short-lived connections and hence measure only the RTT (Round Trip Time) for the aggregate and determine a window for the aggregate. By setting a target performance for the entire aggregate a measurement is made over the aggregate to determine the current performance level for each value of control eg. A RD (Random Drop) probability, or a value of MWA (Modified window Advertisement). If MWA is used and the target is RTT then the algorithm update level and a running measurement of the minimum RTT, is maintained, which is taken to be RTPD (Round Trip Propagation Delay) hence giving the algorithm that computes minimum RTT a long but finite memory. This is achieved by carrying out the following set-ups at each instant update—

(a) Measuring the average RTT over the previous measurement interval and subtracting from this the RTPD estimate to obtain queuing delay.

(b) Adjusting MWA (Wₖ) in the just elapsed measurement interval as follows—Wₖ+1=Wₖ−9ₖ−1ₓ (measured delay-target queuing delay).

(c) Applying the MWA Wₖ+1 over the next measurement.

### CROSS REFERENCE TO RELATED APPLICATIONS:

NOT APPLICABLE

### FEDERALLY SPONSORED RESEARCH:

NOT APPLICABLE

### SEQUENCE LISTING OF PROGRAM:

NOT APPLICABLE

### BACKGROUND OF INVENTION

Field of Invention

The invention relates to a method and apparatus for quality of service control for TCP aggregates at a bottleneck link in the Internet.

A network device that is inserted in the path of traffic in a packet network, and the associated procedures and controller methods, for monitoring the performance of aggregates of short-lived (i.e non-persistent, finite volume, web-like) TCP connections flowing over a bottleneck link and dynamically managing their performance.

At the present time, the predominant use of the Internet (85% to 95%, by various reported measurements) is by so-called “elastic” traffic which is generated by applications whose basic objective is to move chunks of data between the disks of two computers connected to the network. In terms of the volume of data carried, web browsing, email, and file transfers are the main elastic applications. Elastic transfers (or flows) can be speeded up or slowed down depending on the availability of bandwidth. Thus, elastic flows adaptively share the available bandwidth of the network. When there are a few ongoing transfers then the traffic sources can send at a high rate, but when the number of ongoing transfers increases then the sources can only be permitted to send at lower rates.

This adaptive bandwidth sharing in the Internet is achieved by a protocol called TCP (Transmission Control Protocol), which operates between the sender and receiver of every elastic transfer. TCP operates by allowing a certain window of data to be outstanding between the source and the receiver of each transfer. For long transfers, the transfer rate (or throughput) obtained by a given transfer is the average window divided by the average round-trip time between a packet being sent and its acknowledgement being received. TCP adjusts the rate of a transfer by adjusting its window. When packets are being received by the source, acknowledgements are returned. The TCP algorithm, at the source of a transfer, takes this as a sign of available bandwidth, and increases its window. If many transfer attempt to share the network, congestion occurs, some router queue builds up and buffers may overflow, resulting in some packets not being received by senders. TCP senders see the consequent lack of acknowledgements as a sign of congestion, and they reduce their transmission windows, thus reducing the transmission rate of the ongoing transfers.

The basic TCP mechanism, briefly described above, is sufficient to protect the network from congestion collapse, and to keep packets moving in the network. There is, however, no built in mechanism in TCP that assures, say, a preferred class of connections some guaranteed average throughput, or, say, prevents one class of transfers from exceeding the maximum total rate allotted to them.

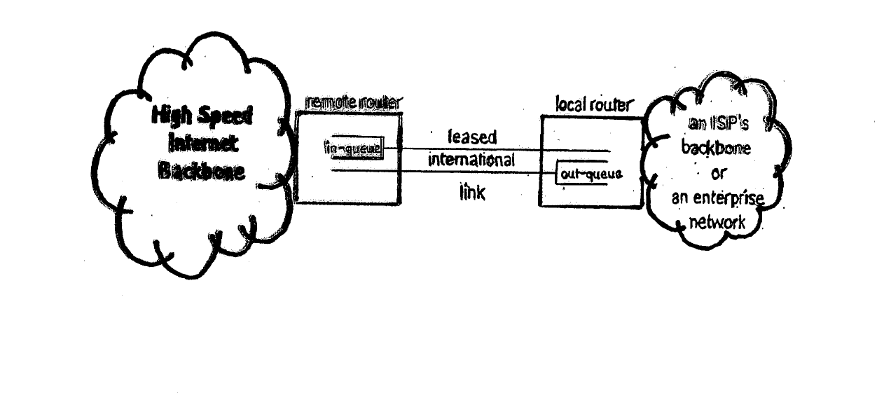

FIG. 1 in the accompanying illustration is a typical situation requiring the control of aggregates of short-lived TCP sessions. To illustrate the problems that arise, the inventors considered the scenario shown in FIG. 1. An ISP sets itself up to serve corporate customers in a certain region (a country, or a state of a country). Much of the traffic that these customs generate is from and to sites in another region that is served by a high speed Internet network. The ISP leases an international link that attaches its own backbone to the high-speed wide area Internet. Such leased international links are very expensive, and the ISP would like to operate its network so that this expensive resource is efficiently utilized. To this end the ISP operates its own backbone at a relatively low utilization, thus ensuring that the bottleneck resource is the expensive international link. A very similar situation would arise when an enterprise or a university attaches its enterprise network or campus network to a high-speed wide area internet by a leased link. Let us denote the bit rate of this leased line by c(bits per sec.).

The ISP would have several corporate customers, with each of whom it would have a Service Level Agreement (SLA). One of the important components of such a SLA would be the aggregate rate at which the customer can sink or source traffic. In practice, traffic generated by web transfers, emails, and transaction oriented applications, and file transfers, comprises finite volume transfers that are requested randomly. So, for example, customer A could be requesting transfers into itself at the rate of λ^{(A)}ᵢₙ transfers per second, each requiring an average of v bits (let us say this is the same for all customers) to be transferred.

This would utilise λ^{(A)}_{inXV=:r}^{(A)} bits per second in the in-bound direction on the ISP's international link. We will denote the aggregate rate assured to A, in the in-bound direction, by a^{(A)}ᵢₙ.

Note that while TCP can control the rate of individual transfers, it can do nothing about the total rate r^{(A)}ᵢₙ. The Total number of ongoing transfers into customer A is a random number N^{(A)}₍ₜ₎ at time t. As r^{(A)}ᵢₙ increase to approach the capacity of the link, N^{(A)}₍ₜ₎ will increase and TCP will reduce the transfer rate obtained by each session, thus keeping r^{(A)}ᵢₙ at whatever value it is, and this is determined entirely by customer A's behaviour.

As the total bit rate received increases, the amount of queuing in the remote router will increase. This will result in an increase in the round-trip time (RTT) of packets, and hence deterioration in the performance by interactive sessions and short web transfers. Thus in addition to being offered an SLA that permits it to sink the assured amount of traffic r^{(A)}ᵢₙ=a^{(A)}ᵢₙ, customer A would also like to get some assurance of the performance obtained by the transfers it makes. This could be in the form of an assurance of some average throughput1, or more simply an assurance of some average round-trip delay experienced by these transfers. Such an assurance can be roughly translated into transfer throughputs obtained by downloads at customer A. Many ISPs include RTT assurances in their SLAs.

More importantly, now consider another customer of the ISP, namely B, with whom the ISP has a SLA that permits B to sink a total average bit rate of a^{(B)}ᵢₙ. Obviously, it is necessary that a^{(A)}ᵢₙ+a^{(B)}ᵢₙ≦C, and in fact the ISP would ensure that this inequality is strict, and the total nominal bit rate is no more than, say, 90% of c. Making the total bit rate much closer than this to c would result in a large queue build-up in the queue called in-queue (in FIG. 1), in the remote router, and in poor transfer throughputs and large RTTs for both customers. Thus, for example, if c=2 Mbps, then the ISP could guarantee the two customers a^{(A)}ᵢₙ=a^{(B)}ᵢₙ 0.9 Mbps.

(Note that it is important to distinguish between the total bit rate of the aggregate i.e, r (A) in, and the throughput obtained by individual flows in this aggregate of flows).

There is, however, nothing to prevent say, customer A from generating traffic so that r^{(A)}ᵢₙ=1 Mbps. Short of denying admission to a fraction of TCP connections from customer A (see [1]) there is nothing that the ISP can do to reduce the aggregate bit rage requested by customer A. Since the total bit rate is now 1.9 Mbps, the number of packets in in-queue increases, and, since the traffic from the two customers shares in-queue, customer B's performance is also adversely affected. Customer B will experience a large RTT, and also a drop in the throughputs of its transfers.

In the above discussion, while we have concentrated on in-bound traffic into the ISP, similar examples can be created for traffic in 1 Note that it is important to distinguish between the total bit rate of the aggregate, i.e r^{(A)}ᵢₙ, and the throughput obtained by individual flows in this aggregate of flows both directions simultaneously.

Existing techniques for TCP performance management, and why they are not adequate for addressing the problems mentioned above.

(a) Bandwidth Management in the Routers: Currently available routers come equipped with performance and bandwidth management mechanisms that can be enabled on each interface. Two of the more commonly implemented ones are the following:

i. Random Early Discard (RED): RED, which is designed to specifically control loss sensitive TCP controlled flows, works by randomly dropping packets of TCP connections, and relying on the TCP senders to reduce their windows. RED can be configured in the remote router so as to control the build-up of in-queue.

ii. Separation of Queuing for Customer Classes: Examples of such mechanisms are weighted Fair Queuing (WFQ) or Class Based Queuing (CBQ). Considering WFQ for example above, at the remote router, in-queue could be spilt into two queues, each of which is assigned equal weight, and hence a nominal assured bandwidth of 1 Mbps.

As a practical matter, however, the higher level service provider, in whose jurisdiction the remote router lies, may not be willing to reconfigure the router to help the lower level ISP satisfy the fine grained SLAs that it wishes to offer its individual customers. In addition, such mechanisms, if invoked in a router may adversely impact its packet forwarding performance. Further, the lower level ISP may wish to automatically reconfigure the packet drop rules depending on the time-of-day, and such a facility is typically not available in routers. It also seems evident that the higherlevel service provider, who may be handling hundreds of such leased lines to smaller ISPs, would be faced with a massive administrative task if it were to respond to frequent requests to reconfigure the packet handling policies in its routers from all its individual customers. In fact, this higher level service provider may simply offer its smaller ISP customer an SLA such as: 2 Mbps bandwidth, with 100% sustainable utilization, 99.99% up-time, and a maximum network delay (at the remote router, looking into the higher level service provider) of 100 milliseconds.

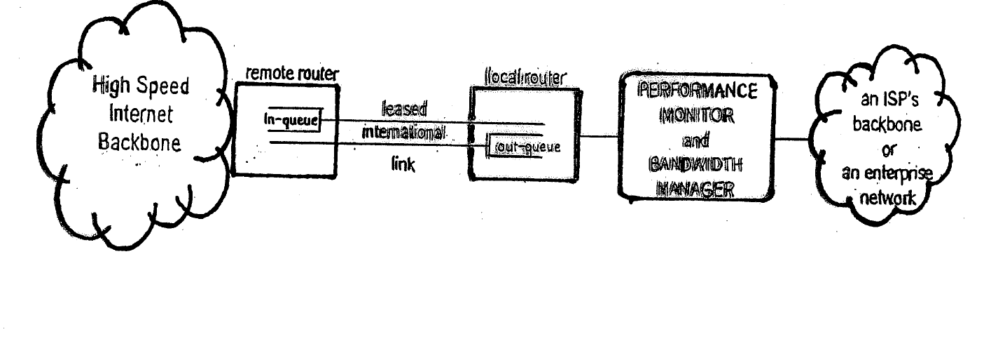

(b) Insertion of a Bandwidth Management Device: The idea of a separate performance management device, inserted into the path of the traffic flowing on the bottleneck link (as shown in FIG. 2), has existed for some years. There are research papers that report such ideas, several patents on such devices exist, and products have been marketed. Such devices have had the following objectives.

i. Admission Control of TCP Connections: In the inventors report implementation of the idea of admission control of TCP connections. Whereas these inventors report a non-intrusive approach, admission control of TCP connections can be even more easily be done by an intrusive device. All such a device needs to do is to look for TCP SYN packets that initiate connections, and based on measurements and some rule (e.g., if the total bit rate into customer A exceeds 1 Mbps, the total bit rate from B is less than 0.9 Mbps, and the total bit rate from A and B exceeds 95% of the link capacity, then block new connections from A), it can simply drop these SYN packets, or send a RESET packet back to the initiator of the connection. Admission control is a drastic measure, however, it cannot be used to address the situation described in the example above: customer A exceeds its allocated rate, but the link is not overloaded. Perhaps in this situation if the applicant can protect customer B's service, customer A would prefer somewhat degraded service rather than having its connections blocked outright. Hence a control approach is needed that can degrade the performance of a misbehaving aggregate more gently.

ii. Performance Management of Individual TCP Connections: There are several proposals and products for managing individual TCP connections. Applicants will review these and discuss how their approach is new and different. All the approaches they review involve inserting a network device in the path of packets of the TCP connections that need to be controlled. Such approaches can also be integrated into a router.

Flood Gate creates queues for one or more TCP sessions. The performance of the TCP connections flowing through the queues is controlled by “serving” or releasing their queued packets according to the desired rate allocations. The approach includes a hierarchical definition of rates; i.e, a total rate can be allocated to a number of connections, and the allocation among the constituent connections may also be specified. The Flood Gate approach involves queuing, and maintaining per queue scheduling information. In the applicants approach they do not use queuing and scheduling of packets; instead they adaptively adjust parameters of TCP aggregates (such as drop probabilities) of finite volume TCP connections in order to control their performance.

The Allot device is basically a proxy that splits the TCP connections passing through it. Thus each connection is terminated at the Allot device and is reinitiated in order to gain control over its performance. Thus the Allot system also aims at explicitly controlling each flow's performance. In the applicants approach the TCP connections are not terminated at their device; instead various parameters of finite volume TCP connection aggregates are adjusted to achieve the desired performance.

Sun Microsystem's Bandwidth Control (4) is another solution which determines dynamically the window size for each connection passing through it. The approach is based on providing some desired bandwidth to individual TCP connections. The window adjustment is based on the measured rate provided to a TCP connection and the rate assigned to it. The Sun approach is also geared towards long-lived connections, since in a situation of short-lived connections (typical of the Internet) where the number of connections is rapidly varying, determining and guaranteeing as per connection rate is not practical. In our approach we aim at an average performance for an aggregate of randomly arriving and departing TCP connections. We aim at a target RTT, which indirectly governs throughput, and dynamically adjust a parameter, such as the maximum window or drop probability, in order to achieve the target average performance.

Packeteer's [5] (see also, [6], [8], [9], approach also aims towards per-flow TCP performance management. Using the so-called, fast rate technique [6] proposed by Packeteer the bottleneck rate along the path of a TCP connection is determined. Using this, and the measured RTT a per-flow window size is computed. Again this approach differs from ours since we aim at the performance of an aggregate of short lived connections, and hence measure only the RTT for the aggregate and determine a window for the aggregate, rather than for individual connections. No per-flow state needs to be maintained, nor do we need to take per-flow actions.

Two research proposals related to dynamically computing window sizes in order to control TCP rate are proposed in [10], [11]. A modified version of [10] is what is used in [5]. In [11] a technique known as the Acknowledgement Bucket scheme for regulating TCP flows is described. However, this is in the context of TCP over ATM. At the Internet-ATM interworking device, the rate provided by the ABR (available bit rate) control at the ATM network interface has to be converted to a TCP window at the Internet interface. The objectives and the approach are completely different from our work.

Proposed Solution: As pointed out in the previous section, none of the existing approaches has considered the problem of performance management of aggregates of randomly arriving short lived TCP connections. Consider first the example of the ISP above, and its customer A, whose aggregate inbound traffic the ISP wants to manage. The ISP can then configure the following traffic management rule into the bandwidth manager: “As long as A's total bit rate is less than 1.8 Mbps, maintain the RTT seen by A's downloads to be no more than 250 ms”. If the higher level service provider has guaranteed an RTT through it of 100 ms, and if the RTPD (round trip propagation delay) over the international leased link is 100 ms, then this implies that the delay in in-queue should be maintained below 50 ms. Left uncontrolled, depending on the statistical characteristics of A's traffic (e.g., heavy tailed transfer volumes) the queuing delay in in-queue could be much larger than 50 ms, even when A's bit rate is less than 0.9 Mbps.

FIG. 2 illustrates the “introduction of an intrusive performance monitor and bandwidth manager into the scenario of FIG. 1”.

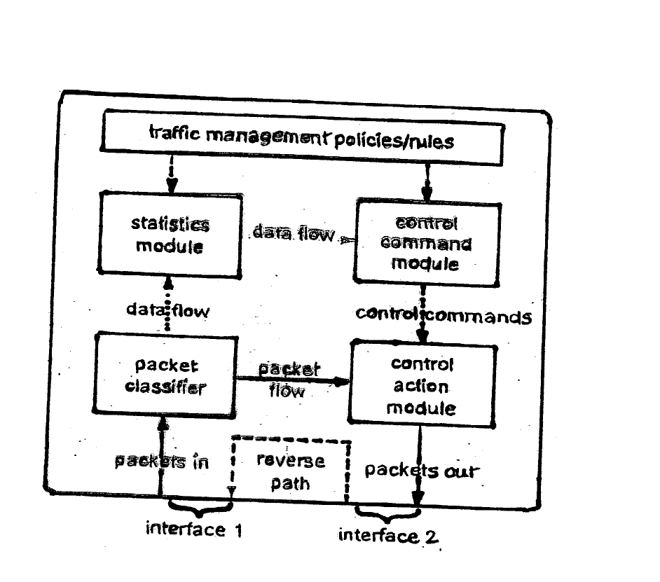

FIG. 3 illustrates the “Schematic of the architecture of the performance monitor an bandwidth manager. The path from Interface 1 to Interface 2 is shown in detail; the same architecture applies in the reverse direction”.

Applicants propose to introduce into the path of traffic a performance management device as shown in FIG. 2. Note that this could also be introduced in to the access router, for example, as an add-on card. The architecture of the software in this device is shown in FIG. 3. The device is attached to the network by two interfaces; traffic flows through the device in both directions. FIG. 3 shows the flow from left to right. There are two paths (i) the “data path”, which is the monitoring and control command path, and (ii) “the packet” path. The network manager can configure the objectives (policies) (“traffic management policies/rules” in FIG. 3). These determine how traffic should be aggregated and what measurements should be made on the aggregates. The “packet classifier” (FIG. 3) classified the packets and provides packet level measurements to the “Statistics module” (FIG. 3). This module computes average measures, and provides them to the “control command module” (FIG. 3) which determines the actions to be taken. The packets themselves are passed on to the “control action module” (FIG. 3) where the pre-aggregate action is applied on the packets (e.g., packets could be dropped randomly at a set rate from a given aggregate).

There are four controls available that we propose to use in the bandwidth manager. These controls will apply to the entire aggregate flow generated by A, and there will be no attempt to identify and control individual TCP connections. Not only does this greatly simplify the control, which achieving the objectives, but for finite volume, short-lived flows it is futile to achieve some “steady state” per flow performance objective. Thus our approach aligns with IETF's Differentiated Services proposals for quality of services in the Internet. The four controls are:

Random Drop (RD): A random drop probability s chosen (adaptively) for the entire aggregate, and packets from the aggregate are dropped randomly according to this drop probability. This results in the average window of the flows in the aggregate to decrease, and hence the queuing in in-queue to decrease.

Forced Delay (FD): A positive delay value is chosen (adaptively) for the entire aggregate, and packets or acknowledgements of this aggregate are delayed by this amount in the bandwidth manager. This makes the RTPD increase causing the queuing in in-queue to decrease.

Modified Window Advertisement (MWA): A maximum congesting window value is chosen (adaptively) for the entire aggregate, and the advertised windows for the flows in the aggregate are set to this value. If the window is set to a value small enough then it will result in reduction of the queuing in in-queue.

Connection Admission Control (CAC): A connection admission probability is chosen (adaptively) for the entire aggregate, and new connections from the aggregate are blocked with this probability. This will be a last resort control, to be used only when the total aggregate offered bit rate to the link is close to or exceeds the link bit rate.

Which control should be used: A combination of the above controls can also be used. Further, it should be noted that if in the in-bound direction the link is near overload, and if RD is used in the in-bound direction, then it will only result in increasing the overload, as packets that are dropped will be resented by TCP, thus adding to the link load. Thus in the in-bound direction only MWA and FD are advisable. In the out-bound direction, however, RD is appropriate since packets are dropped before being carried by the congested link.

Adaptive setting of the control: A target performance can be set for the entire aggregate (e.g., mean RTT, or average flow throughput). Then for each value of control (e.g., a RD probability, or a value of MWA) a measurement is made over the aggregate to determine the current performance level. The deviation from the target value, and an understanding of the sign (i.e, positive or negative) of the adjustment that will yield an improvement in the performance, can then be used to adjust the control. For example, if MWA is used, and there is a target RTT, then the following algorithm can be used.

The algorithm updates MWA periodically, at multiples of a measurement and update interval. A running measurement of the minimum RTT is maintained; this is taken to be the RTPD. Note that the RTPD may change (owing, for example, to a route change in the higher level service provider), but the changes can be expected to be infrequent. Hence the algorithm that computes the minimum RTT should have a long but finite memory. At each update instant the following setups are carried out.

(a) Measure the average RTT over the previous measurement interval and subtract from this the RTPD estimate to obtain the queuing delay.

(b) Adjust MWA (whose value in the just elapsed measurement interval has been, say, Wₖ) as follows:

Wₖ₊₁=Wₖ−gₖ₊₁×(measured queuing delay−target queuing delay)

Where gk+1 is a non negative “gain” factor.

(c) Apply the MWA Wk+1 over the next measurement interval.

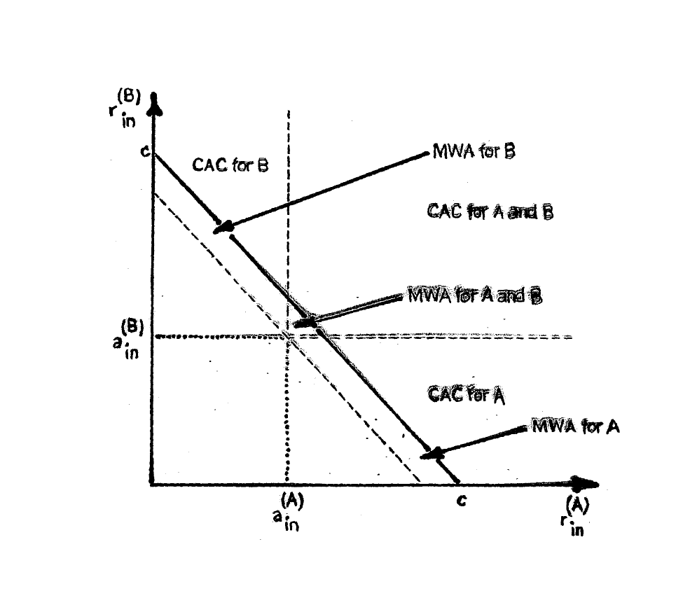

Applicants now turn to the problem of two customers, A and B of the ISP, with each of whom the ISP has an SLA in the in-bound direction. The link is of capacity c bps. The customers are assured average in-bound bit rates of a^{(A)}ᵢₙ and a^{(B)}ᵢₙ (say, 0.9 MBPS each, for a total of 1.8 Mbps, on a 2 Mbps link). The controls in the bandwidth manager can now be configured to operate as shown in FIG. 4. When the total offered bit rate r^{(A)}ᵢₙ+r^{(B)}ᵢₙ is less than or equal to the total assured bit rate a^{(A)}ᵢₙ+a^{(B)}ᵢₙ then a control, such as MWA, can be used if necessary to achieve an RTT SLA. When (r^{(A)}ᵢₙ+r^{(B)}ᵢₙ)>(a^{(A)}ᵢₙ+a^{(B)}ᵢₙ) but r^{(B)}ᵢₙ≦a^{(B)}ᵢₙ, then customer A is exceeding it assured rate. In this case, if (r^{(A)}ᵢₙ+r^{(B)}ᵢₙ)<C then the system will be stable (in the sense that the number of active connections will remain bounded), but the performance seen by downloads initiated by customer B will be poorer than expected. A control such a MWA can then be aggressively applied to flows of customer A, thus degrading their service while maintaining the service to customer B. A small connection dropping probability may also need to be applied to A when the total offered load is less than but close to c. On the other hand, if (r^{(A)}ᵢₙ+r^{(B)}ᵢₙ)≧C then, unless some flows are blocked, the system will become unstable. Hence, CAC needs to applied to customer A's flows. When (r^{(A)}ᵢₙ+r^{(B)}ᵢₙ)>(a^{(A)}ᵢₙ+a^{(B)}ᵢₙ), and both customers exceed their assured rates then, as shown in FIG. 4, a control such as MWA needs to be applied to both customers A and B so long as the total offered bit rate is less than c, otherwise CAC has to be applied to both customer's flows.

In the discussion above we have only considered in-bound traffic into customers of the ISP. The customers could also host web sites or data centres, and hence could source traffic that would result in TCP connections that cause a flow of outbound data traffic on the international leased link of the ISP. An important observation is that the queuing delay in out-queue (see FIG. 2) appears as a “propagation delay” for in-bound flows, whereas the queuing delay in the in-queue appears as propagation delay for out-bound flows. It is thus clear that excessive out-bound traffic can adversely affect the performance of in-bound TCP flows, and vice-versa. As an example, consider a customer A that generates only in-bound traffic, and a customer B that only generates out-bound traffic. The bandwidth manager can now use MWA for the in-bound flow aggregate generated by B. Note that RTT measurements at the bandwidth manager will yield the total queuing delay in in-queue and out-queue. The control vector (MWA window for A, and RD probability for B) needs to be iterated to achieve a given target performance.

The decision in this section has served to illustrate our overall bandwidth management approach with some examples. The approach, however, applies to arbitrary combinations of in-bound and out-bound aggregates of short-lived TCP flows.

We claim:

1) An intrusive bandwidth manager apparatus that manages the average performance of aggregates of finite volume (and hence short-lived) TCP flows, and the associated control methods that need to make only average measurements over the (randomly varying number of) flows in an aggregate, and do not need to maintain per flow state, do not queue packets of the connections in the bandwidth manager, nor do they need to take per individual flow actions in order to achieve the average performance objectives.

2) A router containing the said control method of claim 1.

3) The intrusive bandwidth manager apparatus of claim 1 wherein the said bandwidth manager contains a control method that sets a control parameter (whereby “control parameter” is meant a parameter such as Random Drop Probability, Maximum Window Advertisement, Forced Delay, etc.) for an entire aggregate of finite volume (and hence short-lived) TCP flows.

4) The intrusive bandwidth manager apparatus of claim 1 wherein the said bandwidth manager contains a control method that adaptively adjusts the control parameter (where by “control parameter” is meant a parameter such as Random Drop Probability, Maximum Window Advertisement, Forced Delay etc.) so as to achieve a target average performance for an entire aggregate of finite volume (and hence short-lived) TCP flows.

5) The intrusive bandwidth manager apparatus of claim 1 wherein the said bandwidth manager contains a control method that adaptively adjusts the Maximum Window Advertisement so as to achieve a target average queuing delay using the following method:
i. At step K+1 the following steps are taken
ii. Measure the average round-trip delay over the previous measurement interval and subtract from this the fixed round trip propagation delay estimate to obtain the queuing delay.
iii. Adjust the Maximum Window Advertisement (whose value in the just elapsed measurement interval has been, say, Wk) as follows:
Wₖ₊₁−Wₖ−gₖ₊₁x(measurement queuing delay−target queuing delay)
Where gₖ₊₁x is a non negative “gain” factor.
iv. Apply the Maximum Window Advertisement Wk+1 over the next measurement interval.

6) The intrusive bandwidth manager apparatus of claim 1 wherein the said bandwidth manager contains a control method that includes TCP Connection Admission Control (TCP-CAC), where TCP-CAC is used to improve the convergence properties of an adaptive algorithm for setting the control parameter (where by “control parameter” is meant a parameter such as Random Drop Probability, Maximum Window Advertisement, Forced Delay, etc.), or TCP-CAC is used for shedding excess load from an overloaded link.

7) The control method of claim 1 wherein in the said control method is embedded in a router.
